(19) United States
(12) Patent Application Publication
(10) Pub. No.: US 2019/0326586 A1
(43) Pub. Date: Oct. 24, 2019

(54) LITHIUM ION SECONDARY BATTERY

(71) Applicant: Murata Manufacturing Co., Ltd., Nagaokakyo-shi (JP)

(72) Inventor: Yayoi Katsu, Nagaokakyo-shi (JP)

(21) Appl. No.: 16/502,149

(22) Filed: Jul. 3, 2019

Related U.S. Application Data
(63) Continuation of application No. PCT/JP2018/003421, filed on Feb. 1, 2018.

(30) Foreign Application Priority Data
Mar. 16, 2017 (JP) 2017-051380

(51) Int. Cl. H01M 4/133; H01M 4/62; H01M 2/16; H01M 10/058; H01M 10/0525

(52) U.S. Cl. CPC H01M 4/133; H01M 4/621; H01M 2/16; H01M 2200/10; H01M 4/625; H01M 10/0525; H01M 10/058

(57) ABSTRACT

A lithium ion secondary battery that includes a positive electrode having a positive electrode active material, a negative electrode having a negative electrode active material, and a non-aqueous electrolyte. In this lithium ion secondary battery, ferroelectric ceramics having a Curie temperature equal to or lower than an operating environment temperature are included in at least one of the positive electrode active material and the negative electrode active material.

### CROSS REFERENCE TO RELATED APPLICATIONS

The present application is a continuation of International application No. PCT/JP2018/003421, filed Feb. 1, 2018, which claims priority to Japanese Patent Application No. 2017-051380, filed Mar. 16, 2017, the entire contents of each of which are incorporated herein by reference.

### FIELD OF THE INVENTION

The present invention relates to a lithium ion secondary battery.

### BACKGROUND OF THE INVENTION

In lithium ion secondary batteries, there is known a technique for improving input/output characteristics by including a ferroelectric having a high relative permittivity in at least one of a positive electrode, a negative electrode, and a separator (see Patent Documents 1 to 3).
Patent Document 1: Japanese Patent Application Laid-Open No. 2016-119180
Patent Document 2: Japanese Patent Application

Laid-Open No. 2016-71969
Patent Document 3: Japanese Patent Application Laid-Open No. 2016-39114

### SUMMARY OF THE INVENTION

However, it has been found that the ferroelectric has a Curie temperature at which the permittivity is highest, and when the operating environment temperature of the battery is lower than the Curie temperature, desired high input/output characteristics may not be obtained.

The present invention has been made to solve the above-mentioned problems and its object is to provide a lithium ion secondary battery capable of obtaining high input/output characteristics regardless of the operating environment temperature of the battery.

The lithium ion secondary battery of the present invention includes a positive electrode having a positive electrode active material, a negative electrode having a negative electrode active material, and a non-aqueous electrolyte. In this lithium ion secondary battery, ferroelectric ceramics having a Curie temperature equal to or lower than an operating environment temperature are included in at least one of the positive electrode active material and the negative electrode active material.

The Curie temperature of the ferroelectric ceramics may be equal to or lower than 55° C.

The ferroelectric ceramics may include a barium strontium titanate material represented by (BaₓSr_{y})TiO₃ (where x+y=1), and y may be 0.25 or more and 0.50 or less.

According to the lithium ion secondary battery of the present invention, ferroelectric ceramics having a Curie temperature equal to or lower than an operating environment temperature are included in at least one of the positive electrode active material and the negative electrode active material, whereby high input/output characteristics can be obtained regardless of the operating environment temperature. It is believed that the reason for this is that the ferroelectric is a paraelectric in a temperature region equal to or higher than the Curie temperature, and a polarization direction can be easily changed by the surrounding magnetic field to accelerate movement of lithium ions.

### BRIEF EXPLANATION OF THE DRAWINGS

FIG. 1 is a cross-sectional view of a lithium ion secondary battery according to an embodiment of the present invention.

FIG. 2 is a cross-sectional view showing a configuration of a positive electrode.

FIG. 3 is a cross-sectional view showing a configuration of a negative electrode.

### DETAILED DESCRIPTION OF THE INVENTION

Embodiments of the present invention will be described below, and characteristics of the present invention will be described in more detail.

In the following, a lithium ion secondary battery having a structure in which a laminate formed by alternately stacking a plurality of positive electrodes and negative electrodes with a separator interposed therebetween and a non-aqueous electrolyte are accommodated in an exterior body will be described as an example.

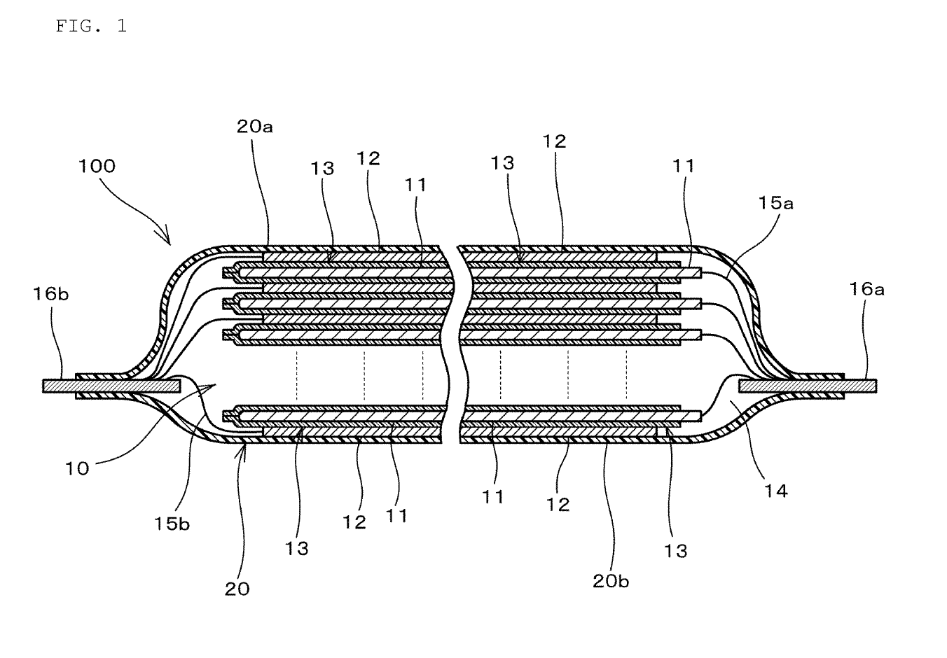

FIG. 1 is a cross-sectional view of a lithium ion secondary battery 100 according to an embodiment of the present invention. In the lithium ion secondary battery 100, a laminate 10 formed by alternately stacking a plurality of positive electrodes 11 and negative electrodes 12 with a separator 13 interposed therebetween and a non-aqueous electrolyte 14 are accommodated in a laminated case 20.

The laminated case 20 which is an exterior body is formed by thermally pressure-bonding and joining peripheral edge portions of a pair of laminate films 20a and 20b.

A positive electrode terminal 16a is drawn out to the outside from one end side of the laminated case 20, and a negative electrode terminal 16b is drawn out to the outside from the other end side. The plurality of positive electrodes 11 are connected to the positive electrode terminal 16a via lead wires 15a. The plurality of negative electrodes 12 are connected to the negative electrode terminal 16b via lead wires 15b.

As shown in FIG. 2, the positive electrode 11 has a positive electrode current collector 21 and positive electrode material layers 22 formed on both sides of the positive electrode current collector 21. As the positive electrode current collector 21, for example, a metal foil such as aluminum foil can be used. The positive electrode material layer 22 contains a positive electrode active material, and may further contain a binder and a conductive additive. For example, lithium cobaltate can be used as the positive electrode active material.

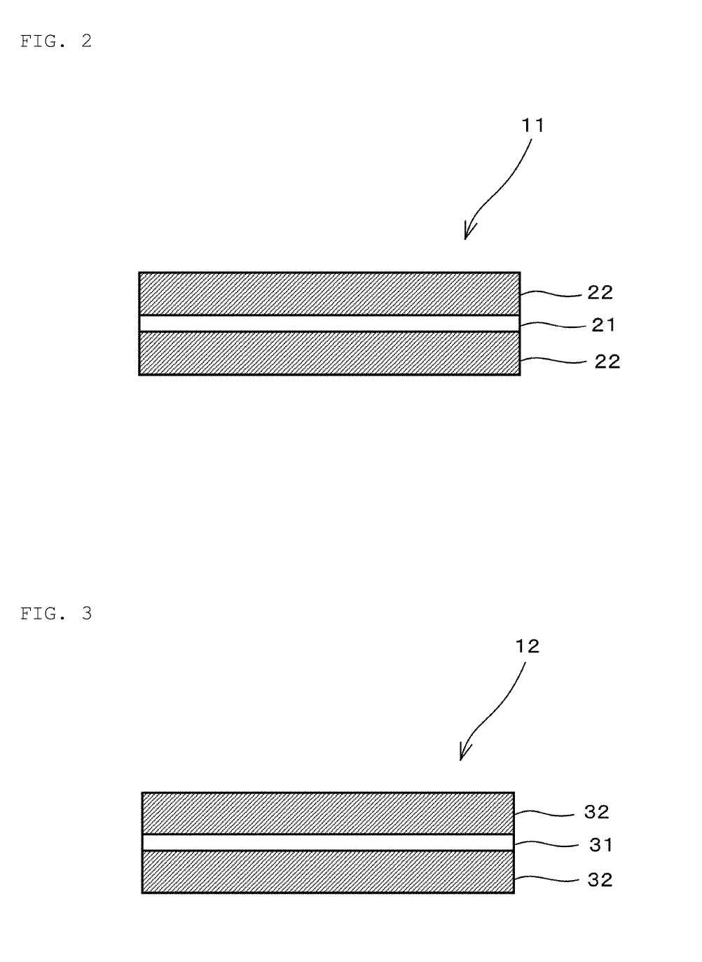

As shown in FIG. 3, the negative electrode 12 has a negative electrode current collector 31 and a negative electrode material layer 32 formed on both sides of the negative electrode current collector 31. As the negative electrode current collector 31, for example, a metal foil such as copper foil can be used. The negative electrode material layer 32 contains a negative electrode active material, and may further contain a binder and a conductive additive. For example, graphite can be used as the negative electrode active material.

In the lithium ion secondary battery 100 in the present embodiment, ferroelectric ceramics having a Curie temperature equal to or lower than an operating environment temperature of the battery are included in at least one of the positive electrode active material and the negative electrode active material. With such a configuration, as described later, the lithium ion secondary battery 100 in the present embodiment can obtain high input/output characteristics.

In other words, the lithium ion secondary battery 100 in the present embodiment exhibits high input/output characteristics when used in a temperature region equal to or higher than the Curie temperature of the ferroelectric ceramics included in at least one of the positive electrode active material and the negative electrode active material.

It suffices that the ferroelectric ceramics are included in the active material, and, for example, the ferroelectric ceramics may be dispersed and included in the active material or may be included such that a portion thereof adheres to the surface.

Here, for example, when the operating environment temperature of the battery is 55° C. or higher, for the ferroelectric ceramics having a Curie temperature equal to or lower than the operating environment temperature of the battery, for example, barium strontium titanate represented by the composition formula (Ba_{0.75}Sr_{0.25})TiO₃ and having a Curie temperature of 55° C. can be used.

When the operating environment temperature of the battery is 0° C. or higher, for the ferroelectric ceramics having a Curie temperature equal to or lower than the operating environment temperature of the battery, for example, barium strontium titanate represented by the composition formula (Ba_{0.6}Sr_{0.4})TiO₃ and having a Curie temperature of 0° C. can be used.

When the operating environment temperature of the battery is −30° C. or higher, for the ferroelectric ceramics having a Curie temperature equal to or lower than the operating environment temperature of the battery, for example, barium strontium titanate represented by the composition formula (Ba_{0.5}Sr_{0.5})TiO₃ and having a Curie temperature of −30° C. can be used.

For the ferroelectric ceramics having a Curie temperature equal to or lower than the operating environment temperature of the battery, for example, a Curie temperature equal to or lower than 55° C., besides the above-described barium strontium titanate, lead-based ferroelectric ceramics containing lead, bismuth-based ferroelectric ceramics containing bismuth, or the like can be used.

Examples of the lead-based ferroelectric ceramics include those in which some Pb of lead titanate represented by the composition formula PbTiO₃ is replaced with Sr and Ba and some Ti is replaced with Zr.

Examples of the bismuth-based ferroelectric ceramics include those in which some Bi or Ti of bismuth titanate represented by the composition formula Bi₄Ti₃O₁₂ is replaced with another element.

For the ferroelectric ceramics such as barium strontium titanate, lead-based ferroelectric ceramics, and bismuth-based ferroelectric ceramics described above, those each having a Curie temperature equal to or lower than the operating environment temperature of the battery are used.

As the separator 13, various separators that can be used for a lithium ion secondary battery can be used without particular limitation. The separator 13 shown in FIG. 1 has a bag-like shape, but may have a sheet-like shape or a zigzag shape.

The non-aqueous electrolyte 14 may be any as long as it can be used for a lithium ion secondary battery, and, for example, a known non-aqueous electrolyte can be used. Alternatively, a solid electrolyte may be used as the non-aqueous electrolyte 14. When a solid electrolyte is used as the non-aqueous electrolyte 14, a separator may become unnecessary.

### Example 1

A graphite as a negative electrode active material and a barium strontium titanate (hereinafter also referred to as BST50) represented by the composition formula (Ba_{0.5}Sr_{0.5})TiO₃ and serving as ferroelectric ceramics having a Curie temperature of −30° C. were each prepared. The prepared graphite and BST50 were mixed such that a weight ratio of graphite:BST50 was 90:10, and dry mixing for 30 seconds was performed twice by using an ultrahigh-speed grinder (Wander blender). In order to improve dispersibility, after the first mixing, powder adhering to an inner wall and a lid of the ultrahigh-speed grinder was removed, and then the second mixing was performed.

A mixed powder obtained by the mixing described above and polyvinylidene fluoride (PVdF) were mixed such that a weight ratio of the mixed powder:PVdF was 92.5:7.5, and then dispersed in N-methyl-2-pyrrolidone (NMP) to prepare a negative electrode slurry. Then, the prepared negative electrode slurry was applied onto a copper foil with a thickness of 10 μm so as to have a thickness of 2.75 mg/cm², dried at 120° C., and then pressed to a density of 1.3 g/cc to produce a negative electrode sheet.

Subsequently, the produced negative electrode sheet was punched into a circular shape having a diameter of 14 mm to produce a negative electrode as an evaluation electrode, and a coin cell including this negative electrode was fabricated. Metallic lithium was used for the positive electrode of the coin cell, and a polyethylene porous film was used for the separator. As a non-aqueous electrolyte, an organic electrolytic solution prepared by dissolving lithium hexafluorophosphate (LiPF₆) in a solvent, obtained by mixing ethylene carbonate and ethyl methyl carbonate in a weight ratio of 1:3, in an amount of 1 mol per 1 L of the solvent was used. The coin cell had a diameter of 20 mm and a thickness of 3.2 mm.

This coin cell is a cell in which ferroelectric ceramics having a Curie temperature of −30° C. are included in the negative electrode active material.

The fabricated coin cell was charged and discharged three times in a voltage range of 0.01 V or more and 2.0 V or less at a current value of 0.25 mA in a thermostat at 25° C., and subsequently charged and discharged once in a voltage range of 0.01 V or more and 2.0 V or less at a current value of 1 mA. The ratio of the charge capacitance obtained when the coin cell was charged and discharged at a current value of 1 mA to the charge capacitance obtained when the coin cell was charged and discharged at a current value of 0.25 mA was determined as a charge capacitance retention ratio.

The temperature of the thermostat was set to 55° C., 10° C., 0° C., or −30° C., and the charge capacitance retention ratio was determined by the same method.

### Example 2

In Example 2, barium strontium titanate having a composition different from that of the barium strontium titanate used in Example 1, that is, barium strontium titanate represented by the composition formula (Ba_{0.6}Sr_{0.4})TiO₃ (hereinafter also referred to as BST40) was used. The Curie temperature of the BST 40 is 0° C.

Also in Example 2, a coin cell was fabricated in the same manner as in Example 1, and the charge capacitance retention ratio was determined. The coin cell of Example 2 is a cell in which ferroelectric ceramics having a Curie temperature of 0° C. are included in the negative electrode active material.

### Example 3

In Example 3, barium strontium titanate having a composition different from those of the barium strontium titanates used in Examples 1 and 2, that is, barium strontium titanate represented by the composition formula (Ba_{0.75}Sr_{0.25})TiO₃ (hereinafter also referred to as BST25) was used. The Curie temperature of the BST 25 is 55° C.

Also in Example 3, a coin cell was fabricated in the same manner as in Examples 1 and 2, and the charge capacitance retention ratio was determined. The coin cell of Example 3 is a cell in which ferroelectric ceramics having a Curie temperature of 55° C. are included in the negative electrode active material.

### Comparative Example 1

In Example 1, barium strontium titanate was mixed with graphite when the negative electrode slurry was prepared; however, in Comparative Example 1, barium strontium titanate was not mixed. That is, graphite and polyvinylidene fluoride (PVdF) were mixed such that a weight ratio of the graphite:PVdF was 92.5:7.5, and then dispersed in N-methyl-2-pyrrolidone (NMP) to prepare a negative electrode slurry.

Also in Comparative Example 1, a coin cell was fabricated in the same manner as in Examples 1 to 3, and the charge capacitance retention ratio was determined. The coin cell of Comparative Example 1 is a cell in which ferroelectric ceramics are not included in the negative electrode active material.

### Comparative Example 2

In Comparative Example 2, in place of the barium strontium titanate used in Example 1, barium titanate represented by the composition formula BaTiO₃ (hereinafter also referred to as BT) was used. The Curie temperature of the barium titanate is 135° C.

Also in Comparative Example 2, a coin cell was fabricated in the same manner as in Examples 1 to 3 and Comparative Example 1, and the charge capacitance retention ratio was determined. The coin cell of Comparative Example 2 is a cell in which ferroelectric ceramics having a Curie temperature of 135° C. are included in the negative electrode active material.

The characteristics of Examples 1 to 3 and Comparative Examples 1 and 2 are shown in Table 1. Table 1 shows the types of ferroelectric ceramics mixed in the negative electrode active material, the Curie temperatures of the ferroelectric ceramics, and the charge capacitance retention ratios at the operating environment temperatures of −30° C., 0° C., 10° C., 25° C. and 55° C.

TABLE 1

| | Type of | | Charge capacitance | | | | |
|---|---|---|---|---|---|---|---|
| | ferroelectric | Curie | retention ratio (%) | | | | |
| | ceramics | temperature | −30° C. | 0° C. | 10° C. | 25° C. | 55° C. |
| Example 1 | (Ba_{0.5}Sr_{0.5})TiO₃ | −30° C. | 8.0 | 54.2 | 68.7 | 76.9 | 95.2 |
| | (BST50) | | | | | | |
| Example 2 | Ba_{0.6}Sr_{0.4})TiO₃ | 0° C. | 1.2 | 47.4 | 68.7 | 78.0 | 96.6 |
| | (BST40) | | | | | | |
| Example 3 | (Ba_{0.75}Sr_{0.25})TiO₃ | 55° C. | 1.3 | 37.7 | 62.6 | 73.8 | 95.5 |
| | (BST25) | | | | | | |
| Comparative | — | — | 1.4 | 37.7 | 62.6 | 74.6 | 94.5 |
| Example 1 | | | | | | | |
| Comparative | BaTiO₃ | 135° C. | 1.2 | 35.4 | 62.1 | 73.0 | 94.4 |
| Example 2 | (BT) | | | | | | |

Compared with the coin cell of Comparative Example 1, in the coin cell of Example 1 in which BST50 having a Curie temperature of −30° C. was mixed with the negative electrode active material, the charge capacitance retention ratio was high at all temperatures of −30° C., 0° C., 10° C., 25° C., and 55° C. That is, when the operating environment temperature was −30° C. or higher, in the coin cell of Example 1 in which ferroelectric ceramics having a Curie temperature of equal to or lower than the operating environment temperature were included in the negative electrode active material, the charge capacitance retention ratio was higher than that in the coin cell of Comparative Example 1.

Compared with the coin cell of Comparative Example 1, in the coin cell of Example 2 in which BST40 having a Curie temperature of 0° C. was mixed with the negative electrode active material, the charge capacitance retention ratio was high at temperatures of 0° C., 10° C., 25° C., and 55° C. That is, when the operating environment temperature was 0° C. or higher, in the coin cell of Example 2 in which ferroelectric ceramics having a Curie temperature of equal to or lower than the operating environment temperature were included in the negative electrode active material, the charge capacitance retention ratio was higher than that in the coin cell of Comparative Example 1.

Compared with the coin cell of Comparative Example 1, in the coin cell of Example 3 in which BST25 having a Curie temperature of 55° C. was mixed with the negative electrode active material, the charge capacitance retention ratio was high at a temperature of 55° C. That is, when the operating environment temperature was 55° C., in the coin cell of Example 3 in which ferroelectric ceramics having a Curie temperature of equal to or lower than the operating environment temperature were included in the negative electrode active material, the charge capacitance retention ratio was higher than that in the coin cell of Comparative Example 1.

Compared with the coin cell of Comparative Example 1, in the coin cell of Comparative Example 2 in which BaTiO₃(BT) having a Curie temperature of 135° C. was mixed with the negative electrode active material, the charge capacitance retention ratio was low at all temperatures of −30° C., 0° C., 10° C., 25° C., and 55° C. That is, when the operating environment temperature was equal to or lower than 55° C., in the coin cell of Comparative Example 2 in which ferroelectric ceramics having a Curie temperature of equal to or lower than the operating environment temperature were included in the negative electrode active material, the charge capacitance retention ratio was lower than that in the coin cell of Comparative Example 1.

That is, it was found that in the lithium ion secondary battery in which ferroelectric ceramics having a Curie temperature of equal to or lower than the operating environment temperature were included in the negative electrode active material, the charge capacitance retention ratio increased, and high input/output characteristics could be obtained. In particular, it was found that when the Curie temperature was equal to or lower than 55° C., the charge capacitance retention ratio increased in a realistic temperature environment where the operating environment temperature was equal to or lower than 55° C., and high input/output characteristics could be obtained.

Although not shown in Table 1, it was found that when ferroelectric ceramics having a Curie temperature of equal to or lower than the operating environment temperature were included in the positive electrode active material, and when ferroelectric ceramics having a Curie temperature of equal to or lower than the operating environment temperature were included in both the positive electrode active material and the negative electrode active material, the charge capacitance retention ratio was higher than that in a lithium ion secondary battery in which no ferroelectric ceramics were included in the active material, and high input/output characteristics could be obtained.

This is considered to be due to the following reason. The ferroelectric exhibits ferroelectricity in a temperature region lower than the Curie temperature, and is a paraelectric in a temperature region equal to or higher than the Curie temperature. When a ferroelectric is included in at least one of the positive electrode active material and the negative electrode active material of the lithium ion secondary battery, a polarization is always generated in the ferroelectric in the temperature region lower than the Curie temperature. It is considered that a polarization direction is not easily changed in this state, and furthermore, a polarization state is not always advantageous for diffusion of lithium ions depending on crystallinity and a domain direction.

However, since ferroelectric is paraelectric in the temperature region equal to or higher than the Curie temperature, the polarization direction can be easily changed by the surrounding magnetic field. That is, it is considered that the fact that the polarization direction is not always in a constant state but is in a changeable state is a factor that movement of lithium ions is accelerated and input/output characteristics are improved.

The present invention is not limited to the above embodiments, and various applications and modifications can be added within the scope of the present invention.

For example, in the above-described embodiment, the lithium ion secondary battery having the structure in which the laminate formed by alternately stacking the plurality of positive electrodes and negative electrodes with the separator interposed therebetween and the non-aqueous electrolyte are accommodated in the exterior body has been described as an example. However, the structure of the lithium ion secondary battery according to the present invention is not limited to the above structure. For example, the lithium ion secondary battery may have a structure in which a wound body formed by winding a positive electrode and a negative electrode stacked with a separator interposed therebetween and a non-aqueous electrolyte are accommodated in an exterior body. The exterior body may not be a laminated case but a metal can.

In the above-described embodiment, barium strontium titanate represented by the composition formula (BaₓSr_{y})TiO₃ (where x+y=1), lead-based ferroelectric ceramics, and bismuth-based ferroelectric ceramics were mentioned as ferroelectric ceramics having a Curie temperature equal to or lower than the operating environment temperature of the battery. However, they are mere examples, and the ferroelectric ceramics are not limited to these examples.

### DESCRIPTION OF REFERENCE SYMBOLS

10: Laminate
11: Positive electrode
12: Negative electrode
13: Separator
14: Non-aqueous electrolyte
20: Laminated case
21: Positive electrode current collector
22: Positive electrode material layer
31: Negative electrode current collector
32: Negative electrode material layer
100: Lithium ion secondary battery

1. A lithium ion secondary battery comprising:
a positive electrode having a positive electrode active material;
a negative electrode having a negative electrode active material;
a non-aqueous electrolyte; and
ferroelectric ceramics having a Curie temperature equal to or lower than an operating environment temperature included in at least one of the positive electrode active material and the negative electrode active material.

2. The lithium ion secondary battery according to claim 1, wherein the positive electrode has a positive electrode current collector and positive electrode material layers on opposed sides of the positive electrode current collector.

3. The lithium ion secondary battery according to claim 2, wherein the positive electrode material layers contain the positive electrode active material.

4. The lithium ion secondary battery according to claim 3, wherein the positive electrode active material is lithium cobaltate.

5. The lithium ion secondary battery according to claim 1, wherein the negative electrode has a negative electrode current collector and negative electrode material layers on opposed sides of the negative electrode current collector.

6. The lithium ion secondary battery according to claim 5, wherein the negative electrode material layers contain the negative electrode active material.

7. The lithium ion secondary battery according to claim 6, wherein the negative electrode active material is graphite.

8. The lithium ion secondary battery according to claim 2, wherein the negative electrode has a negative electrode current collector and negative electrode material layers on opposed sides of the negative electrode current collector.

9. The lithium ion secondary battery according to claim 8, wherein the negative electrode material layers contain the negative electrode active material.

10. The lithium ion secondary battery according to claim 9, wherein the negative electrode active material is graphite.

11. The lithium ion secondary battery according to claim 1, wherein the Curie temperature of the ferroelectric ceramics is equal to or lower than 55° C.

12. The lithium ion secondary battery according to claim 1, wherein the ferroelectric ceramics include a barium strontium titanate material.

13. The lithium ion secondary battery according to claim 1, wherein the barium strontium titanate material is (BaₓSr_{y})TiO₃, where x+y=1, and y is 0.25 to 0.50.

14. The lithium ion secondary battery according to claim 1, wherein the ferroelectric ceramics include lead-based ferroelectric ceramics containing lead.

15. The lithium ion secondary battery according to claim 1, wherein the ferroelectric ceramics include bismuth-based ferroelectric ceramics containing bismuth.
